(19) United States
(12) Patent Application Publication
(10) Pub. No.: US 2005/0168747 A1
(43) Pub. Date: Aug. 4, 2005

(54) Information-encoded tests and method

(76) Inventor: Shaw G. Fox, Bury St Edmunds (GB)

Correspondence Address: Richard L. Sampson;SAMPSON & ASSOCIATES, P.C., 50 Congress Street, Boston, MA, 02109, US

(21) Appl. No.: 10/767,693

(22) Filed: Jan. 29, 2004

(51) Int. Cl. G01N 21/47

(52) U.S. Cl. 356/446

(57) ABSTRACT

A test and method is provided for the analysis of one or more analytes in a fluid test sample. The test includes a carrier of an absorbent material, which exhibits light reflectance within a first spectral range. A plurality of test fields are located on the surface of the carrier, and include test field materials reactive with the analytes and exhibiting light reflectance within a second spectral range. The test fields are located in spaced relation to one another on the carrier, so that gaps between the test fields exhibit light reflectances within the first spectral range. The gaps and test fields have relative sizes which are optically discernable, and which form a coded sequence that correlates to information relating to the test.

### BACKGROUND

1. Technical Field

The present invention generally relates to the field of clinical chemistry. More particularly, the present invention relates to diagnostic test substrates and a method for encoding information therein.

2. Background Information

Throughout this application, various patents are referred to by an identifying citation. The disclosures of the patents referenced in this application are hereby incorporated by reference into the present disclosure.

Tests for the analysis of components in a liquid such as a human body fluid are well known. Typically, such tests include a carrier or substrate made of an absorbent material in which there is absorbed a reagent system which responds to the presence of a pre-selected analyte (e.g., constituent or property of interest) in the test fluid with a visually detectable signal such as a change in color. This change in color, which appears in one or more test fields (pads) of the test substrate, can be the result of an enzymatic reaction in which a redox dye is oxidized or reduced to produce the colored response. Alternatively, the test substrate may be made of a material through which the analyte and labeled antibodies specific therefor can flow to form analyte/labeled antibody conjugates which are captured in a specific detection zone of the test substrate to provide a detectable response when analyte is present in the fluid sample. These devices can employ either a sandwich type format in which the response is directly proportional to the concentration of the analyte in the test fluid or a competitive format where the intensity of the response is inversely proportional to the analyte concentration. While the detectable response obtained using such tests can be observed visually to obtain a qualitative or semiquantitative measure of the analyte in the test sample, greater quantitation and faster, more reliable handling of multiple tests can be realized by reading the developed tests instrumentally, typically by the use of a reflectance spectrophotometer which determines the intensity of reflection from the test field surface.

Examples of such instruments include those sold under the CLINITEK® trademark by Bayer HealthCare LLC (Medfield, Mass.) and/or as disclosed in U.S. Pat. No. 5,408,535. These instruments may be used with reagent test strips such as those sold under the trademark MULTISTIX® (Bayer). These strip readers can detect both the overall color of the test pads and additional features such as small blotches of other colors that may be indicative of other patient conditions.

These instruments determine the intensity of the reflected light in the developed test by illuminating the test substrate with light at one angle (e.g., 90°), detecting the reflected light at a different angle (e.g., 45°) and selecting the measured color or wavelength range at either the source or detector. Conventionally, at the beginning of the test, the operator of the device will input information via a keyboard or other means to tell the instrument what analyte the particular test is designed to detect, so that the read out may be correlated with an appropriate reference. Because of the need for operator input, the degree of automation of the operation is less than complete and various techniques have been developed to further automate the process by providing the tests with indicators from which the device can determine the analyte to which a particular test is directed without the need for operator intervention.

An example of such an automated system is described in U.S. Pat. No. 5,439,826. This disclosure involves a microstrip containing a series of wells for assays in which the individual wells contain a physical characteristic, such as reflectance, in a predetermined order. The instrument detects the presence or absence of the physical characteristic and interprets this as a binary response which correlates with the particular analyte.

In U.S. Pat. No. 4,592,893 there is disclosed an analysis test strip having a test field and a separate bar code for storing batch specific information necessary for the quantitative evaluation of the reaction carried out on the test field. The bar code consists of individual code bars of differing width running substantially transversely to the longitudinal dimension of the test strip. The code bars are of narrow and broad widths and the batch specific information is designed to be interpreted by a reading device in which a narrow bar represents a logical 0 and a wide bar represents a logical 1 with the distances between the code bars providing similar information. The strip reading device is programmed to interpret the logical 0 and 1 responses as a binary code corresponding to the batch specific information imputed to the test strip.

U.S. Pat. No. 5,126,952 discloses a method of providing data in bar code form useful for the determination of the calibration curve of a lot of test elements in a chemical analyzer.

U.S. Pat. No. 5,945,341 to Howard, III, (the '341 patent) discloses an automated method for reading a test strip for the analysis of analytes in a liquid test sample. The method involves the spectrophotometric reading of a test strip which bears at least two marker fields on its surface which are capable of reflecting light at different spectral regions from each other. The reading means of the spectrophotometer is programmed to discern information concerning the strip, such as what analyte the strip is designed to detect, from the sequences of spectral classifications by spectral reflectance measurements of the strip's marker fields.

A drawback of the foregoing approaches, however, is that additional components or indicia, and associated manufacturing steps, are required to apply the identifying information to the test strips. Another drawback of this approach is that the identifying indicia may be easily duplicated by makers of inferior quality, low-cost test strips, which may compromise the quality of patient test results.

A need, therefore, exists for an improved diagnostic test and method for embedding information therein, in a manner that is both easy to embed and easy to read, e.g., without requiring the addition of any components or indicia to the test.

### SUMMARY

An aspect of the present invention includes a test for the analysis of one or more analytes in a fluid test sample. The test includes a carrier of an absorbent material, which exhibits light reflectance within a first spectral range. A plurality of test fields are located on the surface of the carrier, and include test field materials reactive with the analytes and exhibiting light reflectance within a second spectral range. The first and second spectral ranges are distinguishable from one another. The test fields are located in spaced relation to one another on the carrier, so that gaps between the test fields exhibit light reflectance within the first spectral range. The gaps and test fields have relative sizes which are optically discernable, and which form a coded sequence that correlates to information concerning identification of the test.

In another aspect, the test includes a substrate and a plurality of test fields on the substrate. The test fields include test field materials reactive with the analytes. Each of the test fields is configured to generate at least one of a range of responses to incident light. The test fields are located in spaced relation on said substrate to define a series of gaps therebetween. The gaps and the test fields are each configured in one of a plurality of sizes, the sizes forming a coded sequence that correlates to information concerning identification of the test.

A still further aspect of the invention includes a test for the analysis of an analyte in urine. The test includes an elongated carrier of an absorbent material which allows the analyte and labeled antibodies specific thereto to flow through it along with the urine and to form analyte/labeled antibody conjugates. A plurality of test fields are located in spaced relation on the surface of the carrier which captures either the labeled antibody or the analyte/labeled antibody conjugate and is capable of providing an optically detectable response thereto. Gaps between the test fields define a plurality of code fields, the code fields each configured to provide other optically detectable responses which are distinguishable from one another. Each of the code fields and the test fields is sized and shaped to have one of at least two discrete dimensional parameters, the dimensional parameters forming a coded sequence corresponding to information concerning identification of the test.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a perspective view of an exemplary reflectance spectrophotometer which may be used to read tests of the present invention;

FIG. 2 is a perspective view of an embodiment of a test and a test holder used with the spectrophotometer of FIG. 1; and

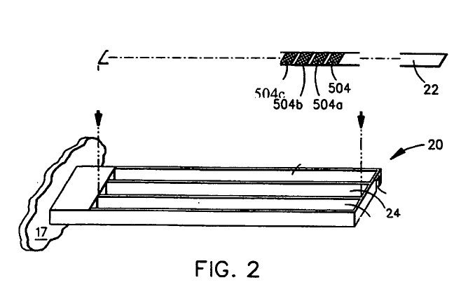

FIG. 3 is a plan view, on an enlarged scale, of portions of the test of FIG. 2.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

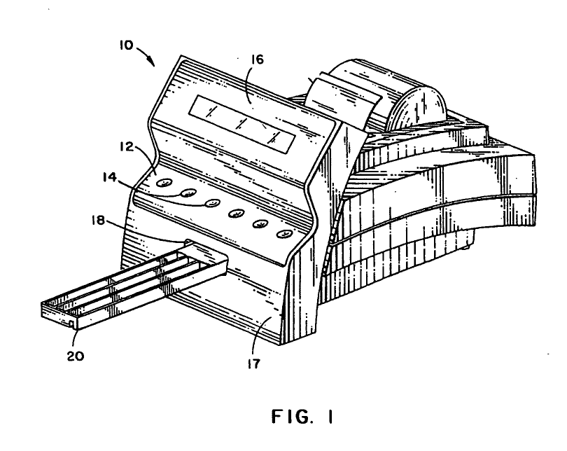

Briefly described, referring to FIGS. 1 & 2, an embodiment of the invention includes a reagent test 22 which has been embedded with encoded information by varying the location of test pads 504 thereon. Advantageously, this approach provides a relatively simple and accurate means for embedding useful information, without adding any components or indicia to the strip. This approach also facilitates the accurate decoding of the embedded information by otherwise conventional test analysis instrumentation.

Test 22, which can be in the form of a strip, cassette, cartridge or other suitable format, is used for the analysis of one or more analytes in a fluid test sample, and includes a substrate having a series of test fields (e.g., pads) 504, 504a, 504b, etc., disposed in spaced relation thereon. The substrate and test pads may be of conventional construction, with the test pads fabricated from commonly used test field materials which are reactive with one or more analytes of interest. Reaction with an analyte of interest serves to generate a detectable response in the test pads, such as a color change. This color change is detectable either manually or by use of a reflectance spectrophotometer 10 discussed below.

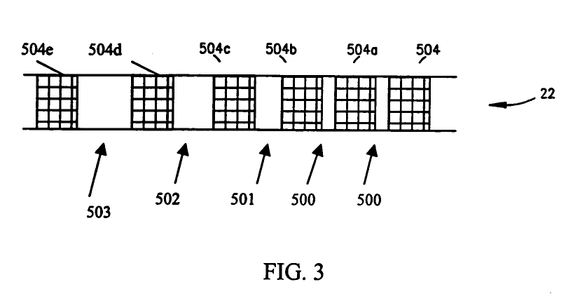

As best shown in FIG. 3, the test pads 504, 504a, etc., are disposed in spaced relation on the substrate to define a series of gaps 500, 501, 502, 503, therebetween. These gaps (and/or the pads) are each configured to have a predetermined size, e.g., width, the widths being arranged on the strip in a predetermined order to form a coded sequence. Examples of the type of information that may be encoded include the particular reagents and analytes, and other identifying information associated with the particular test. The coded sequence may employ any number of conventional coding systems to represent the specific information.

Examples of conventional sample media useful with embodiments of this invention include, but are not limited to, the aforementioned MULTISTIX® urine analysis tests. For convenience and clarity, embodiments of the present invention are described herein as using a substrate 22 in the general form of a test strip modified pursuant to the teachings hereof. It is to be understood, however, that the teachings of the present invention may be applied to substantially any form or type of substrate, including but not limited to immuno cassettes such as CLINITEST® (Bayer) hCG cassettes.

Where used in this disclosure, the term “axial” refers to a direction substantially parallel to longitudinal dimension of substrate 22 (FIG. 3). The term “transverse” refers to a direction other than substantially parallel to the axial direction. Also, the term “light” broadly refers to nominally any type of radiation, including electromagnetic (EM) radiation in or out of what is commonly considered to be the visible spectrum. This term may thus include EM radiation in the infra-red (IR) and/or ultra-violet (UV) ranges, or beyond.

Software associated with instrumentation used in various embodiments of the present invention may be written in any suitable language, such as C++; Visual Basic; Java; VBScript; Jscript; BCMAscript; DHTM1; XML and CGI. Any suitable database technology may be employed, including but not limited to versions of Microsoft Access and IMB AS 400.

Particular embodiments of the present invention will now be described in greater detail. Turning now to FIG. 1, substrate 22 may be used with a reflectance spectrophotometer 10 of the type commonly used for performing various tests, including urinalysis tests. Spectrophotometer 10 may include a conventional CLINITEK® device discussed above, and/or may include a device as described in the above-referenced '341 patent. As shown, this exemplary spectrophotometer 10 has an integral keyboard 12 with a number of entry keys 14 that may be depressed by the user. A visual display 16 for displaying various messages relating to operation of spectrophotometer 10 is disposed above the keyboard 12.

Referring to FIGS. 1 & 2, spectrophotometer 10 has a front face 17 and an opening 18 therein in which a holder 20 for carrying test substrate 22 is retractably disposed. The holder 20 has a central channel 24 sized to conform to the shape of the substrate 22.

As discussed above, reagent test substrate 22 includes a relatively thin strip on which are laid a number of relatively absorbent layers of material impregnated with reagents in specific locations referred to herein as test fields or test pads 504, 504a, etc. The test pads are configured to exhibit a response, such as a color change, which is readable by spectrophotometer 10, as an indication of the presence and/or concentration of a particular analyte in a test fluid such as blood or urine. In this regard, when an end of substrate 22 makes contact with a fluid test sample such as urine, the liquid migrates along the substrate, due to the absorbent nature of the substrate material, into contact with the test pads 504, 504a, etc.

Referring now to FIG. 3, embodiments of the present invention enable tests of various types to be accurately identified without adding any additional structural features or indicia. This identification is accomplished by varying the positions of individual test pads 504, 504a, etc., on the test substrate 22 to encode various messages. These embodiments may be particularly useful in distinguishing between substrates having the same number of test pads, which otherwise may be difficult to distinguish from one another.

As also discussed above, spacing of the test pads defines a series of gaps 500, 501, 502, etc., therebetween. The size (e.g., width, in a direction parallel to the axial direction of the strip) of the pads may be provided by cutting the pads to predetermined sizes. The size of the gaps is then controlled by precise placement of the pads onto strip 22.

In a relatively basic embodiment, gaps of two discrete sizes, 500 and 501, may be used, to enable use of a binary encoding system, for example, in which the narrower gap 500 may represent a logical “0”, and the wider gap 501 may represent a logical “1”. In this embodiment, a substrate 22 having n gaps, which are either narrow (500) or wide (501), may encode 2ⁿ bits. An 8-way test substrate (8 pads, 7 gaps), would thus enable 2⁷ (i.e., 128) discrete combinations, to accurately distinguish up to 128 types of substrate having the same number of pads.

Another exemplary embodiment includes a 10-way substrate (9 gaps), having gaps of three widths 500, 501, and 502 as shown. This embodiment may be used to encode 3⁹ (or 19,683) discrete combinations or substrate types. Similarly, a 10-way substrate having gaps of four widths 500, 501, 502, and 503, may encode 4⁹ (or 262, 144) discrete combinations or substrate types.

Although the foregoing examples describe embodiments having uniform pad sizes and varying gap sizes, the skilled artisan will recognize that the opposite approach, namely, the use of uniform gap sizes and varying pad sizes, may be used without departing from the spirit and scope of the present invention. Moreover, a combination of varying gap and pad sizes may be used to encode a proportionately greater amount of information than that provided by varying only the pads or gaps.

The skilled artisan will thus recognize that the amount of information which may be encoded pursuant to the present invention is determined in part by the precision with which the pads 504, 504a, etc., are cut and/or placed on the substrate, and by the ability of the system (e.g., spectrophotometer 10) used to resolve the width of the gaps 500, 501, etc., and/or the pads.

The various coded sequence combinations may be used to identify any number of features associated with a particular test substrate 22, such as identification of the particular reagents, analytes, and/or date of manufacture or expiration date thereof. Any convenient coding system, such as those commonly used in the field of digital communications, may be used to encode the substrates. One convenient approach may be to simply provide a unique coded sequence for each type of test substrate 22. The particular coded sequence may then be compared to a lookup table stored in the memory of spectrophotometer 10 to identify the corresponding features.

While gaps of up to four distinct sizes, 500, 501, 502, and 503, are shown, it should be apparent that nominally any number of discrete gap and/or pad sizes may be used, without departing from the spirit and scope of the present invention. Moreover, any number of conventional error checking algorithms may be employed by spectrophotometer 10 to reduce errors in the decoding of the coded sequence. Exemplary error checking may simply include use of a checksum, and/or may include the use of relatively sophisticated error checking algorithms of the type commonly used in the field of digital communications.

Having described exemplary embodiments of the invention, the following is a description of the operation thereof. To carry out an analysis of a liquid test sample, such as a urinalysis, the reagent substrate 22, e.g., in the form of a urinalysis test strip, is dipped into a urine sample and then placed in the central channel 24 of the spectrophotometer holder 20. The operator may then operate the spectrophotometer 10 in a conventional manner, such as by pressing one of the keys 14 to initiate testing by retracting the holder 20 into the spectrophotometer 10. After this retraction, the spectrophotometer may ‘read’ the substrate, such as by actuating a light source to illuminate test substrate 22. The spectrophotometer may then capture light reflected from substrate 22 in a conventional manner, such as described in the above-referenced '341 patent, to determine the color thereof.

In this regard, while the test pads will respond to the incident light in one manner (e.g., by reflecting light within a particular color range), the gaps will respond to the incident light in another manner which is distinct therefrom. In one embodiment, the gaps (e.g., the portions of the substrate exposed between the pads) may simply absorb the incident light, or alternatively, may reflect the light in a range of wavelengths (colors) distinct from that of the test pads. For example, a white substrate may be used, which would tend to reflect white light at the location of the gaps 500, 501, while the test pads may be configured to reflect light only within a particular color band. Spectrophotometer 10 may thus detect the responses of the gaps and pads explicitly, by detecting their particular reflectance signatures. Alternatively, spectrophotometer 10 may identify the responses of the gaps implicitly, by noting discontinuities (i.e., axial breaks) in the light pattern reflected by the test pads, which may occur due to absorption (rather than reflection) of incident light at the gaps 500, 501. The spectrophotometer may then measure the relative strength/intensity(e.g., width) of these reflectances or discontinuities (e.g., due to the gaps) to determine the size of the gaps and pads.

The coded sequence may then be identified and decoded, such as by comparison with a lookup table stored in the memory of the spectrophotometer 10 as mentioned above. In this manner, the spectrophotometer 10 may determine the various parameters, e.g., reagents, analytes, reactivities, and any other information, which may be desired to accurately read the particular test substrate 22.

Moreover, although spectrophotometer 10 has been shown and described herein, substantially as described in the above-referenced '341 patent, other types of analytic devices of types familiar to those skilled in the art may be used.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

1. A test for the analysis of one or more analytes in a fluid test sample, the test
comprising:
a carrier of an absorbent material;
said carrier exhibiting light reflectance within a first predetermined spectral range;
a plurality of test fields on the surface of the carrier;
said test fields including a plurality of test field materials reactive with the one or more analytes and exhibiting light reflectances within a second predetermined spectral range;
said first and second predetermined spectral ranges being distinguishable from one another;
said plurality of test fields being disposed in spaced relation to one another on the carrier, wherein gaps between the test fields exhibit light reflectance within said first predetermined spectral range;
said gaps and said test fields having relative sizes which are optically discernable;
said relative sizes forming a coded sequence that correlates to information relating to the test.

2. A test for the analysis of one or more analytes in a fluid test sample, the test comprising:
a substrate;
a plurality of test fields on said substrate;
said test fields including a plurality of test field materials reactive with the one or more analytes;
each of said test fields configured to generate at least one response within a range of responses, to light incident thereon;
said test fields disposed in spaced relation on said substrate to define a series of gaps therebetween;
said gaps and said test fields each being configured in one of a plurality of predetermined sizes;
said predetermined sizes being disposed to form a coded sequence that correlates to information relating to the test.

3. The test of claim 2, wherein the test fields comprise test pads.

4. The test of claim 2, wherein said at least one response within a range of responses comprises reflectance within a predetermined spectral range.

5. The test of claim 2, wherein the strength of said at least one response is proportional to the relative size of said test field.

6. The test of claim 2, wherein each of said gaps is configured to generate at least one other response within another range of responses to light incident thereon, said at least one other response being proportional to the relative size of said gap.

7. The test of claim 6, wherein said at least one other response comprises absorption of light incident thereon.

8. The test of claim 6, wherein said at least one other response within a range of other responses comprises reflectance within a predetermined spectral range.

9. The test of claim 6, wherein said at least one response within a range of responses comprises reflectance within a predetermined spectral range, and said at least one other response within another range of responses comprises reflectance within another predetermined spectral range.

10. The test of claim 2, wherein said substrate comprises a carrier fabricated from an absorbent material.

11. The test of claim 2 wherein the substrate is elongated, having a longitudinal axis.

12. The test of claim 11 wherein the gaps are elongated and extend substantially parallel to one another in a direction transverse to said longitudinal axis.

13. The test of claim 11, wherein said predetermined sizes comprise width dimensions of each of the gaps and the test fields, in a direction parallel to said longitudinal axis.

14. The test of claim 13, wherein said coded sequence is defined by the relative width of said gaps.

15. The test of claim 13, wherein said coded sequence is defined by the relative width of said test fields.

16. The test of claim 13, wherein said coded sequence is defined by a combination of the relative widths of said gaps and the relative widths of said test fields.

17. The test of claim 2 wherein the substrate is fabricated from a material which allows the one or more analytes and labeled antibodies specific thereto to flow through it along with the fluid test sample and to form analyte/labeled antibody conjugates which can be captured in a specific capture zone of the test.

18. The test of claim 2, wherein said predetermined sizes comprise at least two optically discernable sizes.

19. The test of claim 18, wherein said predetermined sizes comprise at least four optically discernable sizes.

20. The test of claim 2 wherein said information comprises identification of the one or more analytes for which the test is designed to test.

21. The test of claim 20 wherein said information comprises information relating to the production batch from which the test was obtained, and the date of manufacture of the test.

22. A test for the analysis of an analyte in urine which comprises:
a) an elongated carrier of an absorbent material which allows the analyte and labeled antibodies specific thereto to flow through it along with the urine and to form analyte/labeled antibody conjugates;
b) a plurality of test fields disposed in spaced relation on the surface of the carrier which capture either the labeled antibody or the analyte/labeled antibody conjugate and are capable of providing a first optically detectable response thereto;
c) gaps between said test fields defining a plurality of code fields, the code fields each configured to provide second optically detectable responses which are distinguishable from said first optically detectable responses;
d) each of said code fields and said test fields sized and shaped to have one of at least two discrete dimensional parameters, said dimensional parameters forming a coded sequence corresponding to information relating to the test.

23. An automated method of reading a test for the analysis of one or more analyte(s) in a liquid test sample which comprises the steps of:
a) providing a test as set forth in claim 2;
b) introducing the test into a reading device equipped with an optical reader and a correlator, the reader configured to read the test fields and the gaps, the reader including a light source as transmitter and a light sensitive element as receiver which receiver is capable of differentiating between the at least one response of the test fields and the gaps, to determine the relative size of the gaps and test fields, and the correlator configured to correlate the coded sequence with stored information concerning the test;
c) allowing the at least one response of the test fields and the coded sequence to be read by the reader; and
d) allowing the reader to communicate the coded sequence to the correlator and allowing the correlator to correlate the coded sequence with information concerning the test.

24. The method of claim 23 wherein the reader is capable of acquiring spatial and spectral reflectances across the length of the test.

25. The method of claim 23 wherein the information concerning the test strip comprises information based on the particular batch from which the test was obtained.

26. The method of claim 23 wherein the information concerning the test relates to which analyte or analytes the test is designed to analyze.
